(19) United States
(12) Patent Application Publication
(10) Pub. No.: US 2011/0225288 A1
(43) Pub. Date: Sep. 15, 2011

(54) METHOD AND SYSTEM FOR EFFICIENT STORAGE AND RETRIEVAL OF ANALYTICS DATA

(75) Inventors: JOHN L. EASTERDAY, Beaverton, OR (US); MUKESH DALAL, Portland, OR (US)

(73) Assignee: Webtrends Inc., Portland, OR (US)

(21) Appl. No.: 12/723,527

(22) Filed: Mar. 12, 2010

(51) Int. Cl. G06F 15/173

(52) U.S. Cl. 709/224; 709/223

(57) ABSTRACT

A method and system for efficient storage and retrieval of current and historical analytics data. The method includes reading current event data and historical event data associated with a visitor from an analytics data store and producing one or more metrics based on the current or historical event data. Delta data is generated using the current and historical event data. The delta data is then combined with previously aggregated data to produce new aggregated data. A system includes an analytics data store. The analytics data store includes a plurality of analytics data store entities arranged chronologically in time. Each analytics data store entity includes a plurality of sub bands of data. Each sub band of data is associated with configurable data blocks. The analytics data store entities also include meta data portions for increasing the efficiency of storage and retrieval of information to and from the analytics data store entities.

### BACKGROUND OF THE INVENTION

This disclosure relates to web traffic analytics, and, more particularly, to a method and system for efficient storage and retrieval of web traffic analytics data.

The Internet has transformed the world. Vast quantities of data are proliferating throughout the Earth, causing significant challenges; these challenges, in turn, are driving the development of improved methods for parsing, processing, and storing the deluge of data. Categorizing or otherwise making sense of such information is another significant challenge—one that is causing businesses, individuals, and governments to seek out high-technology solutions to more efficiently process and/or store the information. Such attempts are largely intended for gaining a better understanding, among other purposes and motives. For example, some motives might include enhancing a business model, tracking diverse political movements, engaging with customers, or evaluating a competitor's product or service, among other purposes. Quite simply, by gaining a complete understanding of the information and data around us, agendas can and will, as a result, be advanced.

By its very nature, the Internet provides an interactive experience between the web site visitor and the web server. The web server can gather information about each visitor by observing and logging the web traffic data exchanged between the web server and the visitor. Important details about the visitors and their visits to web sites can be determined by analyzing the web traffic data and the context of the “hit.” Further, web traffic data collected over a period of time can yield statistical information, otherwise know as web traffic “analytics” data, such as the number of visitors visiting the site each day, demographic information, or frequency of returning visitors, etc. Such web traffic analytics data is useful in tailoring marketing or other strategies to better match the needs of the visitors.

However, as the number of web site visitors increases for a given web server or group of related web servers, the computational and storage requirements for generating and storing the web traffic analytics data and any associated reports significantly increase as well. This can cause delays in processing, data bottlenecks, web server down time, and other serious challenges. Conventional techniques for tracking and storing web traffic analytics data such as unique visitor counts, is computationally expensive and presently implemented with inefficient storage techniques.

Accordingly, there remains a need for a way to improve the organization and storage of web traffic analytics data so that the efficiency of web analytics systems can be enhanced.

It would be desirable to group data in logical and organizational constructs so that the web traffic analytics data can be efficiently stored and retrieved for processing.

It would also be desirable to manage historical data in such a way that an aggregation of data over time can be performed using deltas in the data, thereby providing a proficient and economical solution to these and other challenges.

### BRIEF DESCRIPTION OF THE DRAWINGS

FIG. 1 shows an example diagram of some aspects related to a technique for generating and storing aggregated web traffic analytics data, according to an embodiment of the invention.

FIG. 2 shows an example diagram of other aspects related to the technique illustrated in FIG. 1.

FIG. 3 illustrates an example diagram of additional aspects and components related to the technique for generating and storing aggregated web traffic analytics data illustrated in FIG. 1.

FIG. 4 illustrates a system for generating delta data from hit data, and final reports, according to some embodiments of the present invention.

FIG. 5 illustrates an example diagram of an analytics data store, and related aspects and components associated therewith.

FIG. 6 shows another example of an analytics data store, including historical data replication and other inventive aspects.

FIG. 7 shows a system for processing information organized into bands and sub-bands, thereby efficiently processing and storing the information according to another example embodiment of the invention.

FIG. 8 shows a system for caching portions of the analytics data store using local machines, according to yet another example embodiment of the invention.

FIG. 9 shows a flow diagram for reading, processing, and storing event data to produce aggregated data according to an example embodiment of the invention.

### DETAILED DESCRIPTION OF THE PREFERRED EMBODIMENT

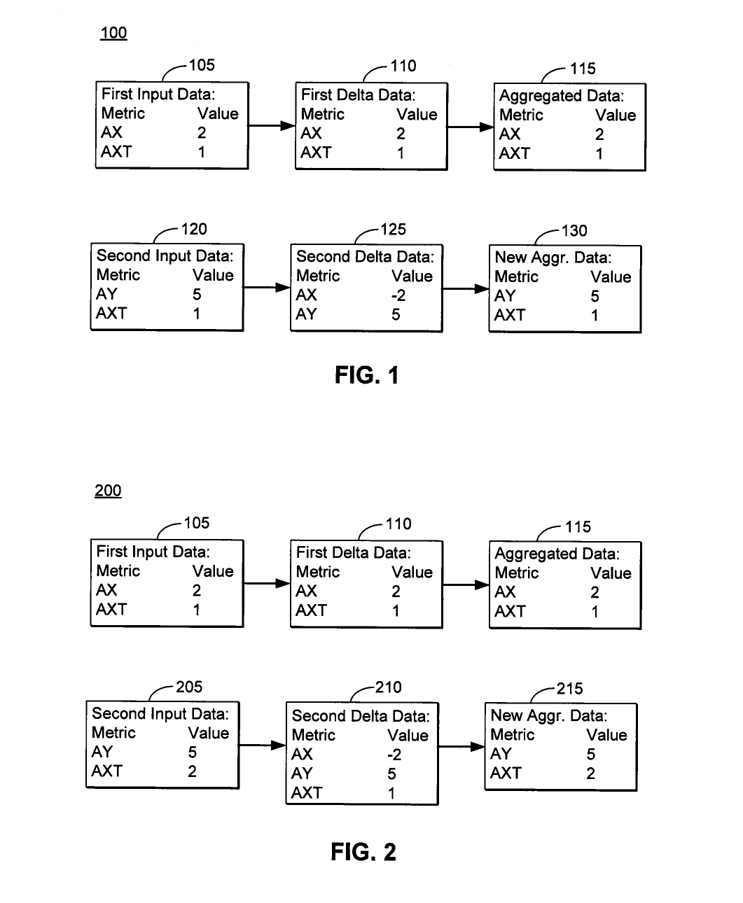

FIG. 1 shows an example diagram 100 of some aspects related to a technique for generating and storing aggregated web traffic analytics data, according to an embodiment of the invention. In particular, an analytics data store (ADS) storage mechanism having unique features and methods for organizing and processing analytics information are disclosed. The various inventive aspects of the present disclosure are designed to be used as a web traffic analytics data processing system, or as part of an analytics data processing system. The disclosed systems and techniques offer reduced storage requirements for web traffic analytics data, efficient storage update procedures, efficient data retrieval and processing, reduced analytics data processing times, among other features and advantages.

Input data 105 includes one or more metrics, such as AX and AXT. The metrics can represent various dimensions, such as geographical information, query parameters, string values, web pages visited, most popular web pages visited, time spent by a visitor at a particular web page, products purchased, customer-specific needs, etc. The metrics can also represent, for example, unique visitor counts over a period of time for a given dimension, or other visitor-level dimensions. Each of the metrics has a value. For example, the AX metric of first input data 105 has a value of 2 and the AXT metric of first input data 105 has a value of 1. It should be understood that the metrics can have any value as determined by the first input data 105. The input data can be derived from event data organized in discrete time buckets and stored in an analytics data store, as will later be described in detail.

In the technique illustrated in FIG. 1, the first delta data 110 is generated using the first input data 105. In this case, the first input data 105 is the initial set of data, and therefore, the AX and AXT metrics of the first delta data 110 are equivalent to the AX and AXT metrics of the first input data 105. Moreover, the first delta data 110 is stored as aggregated data 115 because in this case, there is no previously aggregated data with which to combine the first delta data 110. Thus, the AX metric has an aggregated value of 2 and the AXT metric has an aggregated value of 1, thereby matching the initial set of data.

Thereafter, new input data such as second input data 120 can be processed. The second input data 120 can include new metrics that are associated with changes in the underlying visitor data, event data, or other related data. Some of the new metrics, such as AXT, can overlap with the previous metrics of the previous input data 105. Conversely, some of the new metrics, such as AY, may be entirely new, i.e., processed for the first time. Still other metrics, such as previous AX metric, may not appear at all in the new input data 120. In this example, new AY metric has a value of 5 and the AX metric is not included. Metric AXT remains at a value of 1; in other words, AXT remains with the same value as before.

The delta data 125 can now be generated using current and historical information. For example, given that the second input data 120 does not include the AX metric, a negative metric is generated to remove a portion of the previously aggregated data. More specifically, in the absence of the AX metric in the second input data 120, the AX metric is assigned a value of −2 in the second delta data 125 because the historical value of AX was 2. When the AX metric is eventually combined with the previously aggregated data 115, the AX portion of the previously aggregated data is removed. Thus, the new aggregated data 130 does not include the AX metric.

The AY metric in the second delta data 125 remains with a value of 5 because the AY metric is being processed for the first time. The delta data 125 does not include the AXT metric because there was no change between the historical value of 1 and the current value of 1. In other words, the delta data accounts for changes in the underlying visitor data, event data, or other related data, and does not comprise the underlying visitor or event data itself. It is not desirable to count the AXT metric again because, for example, it might represent the same visitor that was already previously counted for a particular dimension.

Consider an example where the AXT metric measures the number of unique visitors to a given web page from a geographical location over the course of a predefined time period, e.g., the number of unique visitors from California over the course of one year. In such a scenario, assume that the historical count is 1, meaning that one unique visitor has visited the web page so far. If still within the predefined one year time period, and if the same visitor visits the web page again, we would not want to count the second visit because our intention in this example is to aggregate unique visits to the web page over the course of the one year. Thus, if the AXT metric has a current value of 1 representing a current visit by the visitor, and a historical value of 1 representing a previous visit by the same visitor to the same web page, then no additional unique visits have occurred; therefore, the second delta data 125 does not include the AXT metric.

When the second delta data 125 is combined with the previously aggregated data 115, the result is new aggregated data 130. The new aggregated data 130 includes the AY metric having a value of 5 and the AXT metric having a value of 1. As previously mentioned, the AX metric was effectively removed from the aggregated data using the negative metric value. Thus, this technique provides incremental update of visitor-level and/or unique count metrics, among other incremental aggregation features.

FIG. 2 shows an example diagram 200 of other aspects related to the technique illustrated in FIG. 1. In this example, the input data 105, delta data 110, and aggregated data 115 are the same as the example in FIG. 1. Of note, however, is that the AXT metric of the second input data 205 has a value of 2 instead of 1. In this scenario, the second delta data 210 will include a negative metric AX, and the AY metric will have a value of 5, in similar fashion to that described above. But in addition to these metrics, the second delta data 210 will also include the AXT metric, which will be assigned a value of 1. The AXT metric is assigned a value of 1 in the second delta data 210 because the AXT metric has a value of 2 in the second input data 205 and a historical value of 1. In other words, the change in the value of the AXT metric from 1 to 2 causes the AXT metric to be assigned a value of 1 in the second delta data 210.

Similar to the example above, the AXT metric represents the number of unique visitors to a given web page from a geographical location over the course of a predefined time period, e.g., the number of unique visitors from California over the course of one year. In this case, assume that the historical count is 1, meaning that one unique visitor has visited the web page so far. If still within the predefined one year time period, and if a new visitor visits the web page, we want to count the visit of the new visitor because one of our intentions in this example is to aggregate unique visits to the web page over the course of the one year. Thus, if the AXT metric has a current value of 2 representing a current visit by both the original visitor and the new visitor, and a historical value of 1 representing a previous visit by the original visitor to the same web page, then one additional unique visit has occurred; therefore, the second delta data 210 will include the AXT metric having the value of 1. In such manner, the delta data can be generated by reviewing the historical event data and comparing the current event data to the historical event data.

When the second delta data 210 is combined with the previously aggregated data 115, new aggregated data 215 is produced, which includes the AY metric having the value of 5 and the AXT value having the value of 2. In other words, the aggregated AY metric is a new metric and maintains its value of 5. The aggregated AXT metric includes the previous value of 1 added to the delta value of 1, thereby resulting in a value of 2. As previously mentioned, the AX metric was effectively removed from the aggregated data using the negative metric value.

In this manner, incremental updates of web traffic analytics metrics can be performed. The accumulated information can include one or more unique visitor counts, or any other metric related to web traffic analytics. Analytics data can be efficiently accumulated over a period of time so that the new aggregated metrics continually reflect the latest data available, which can be output in the form of one or more reports at any time.

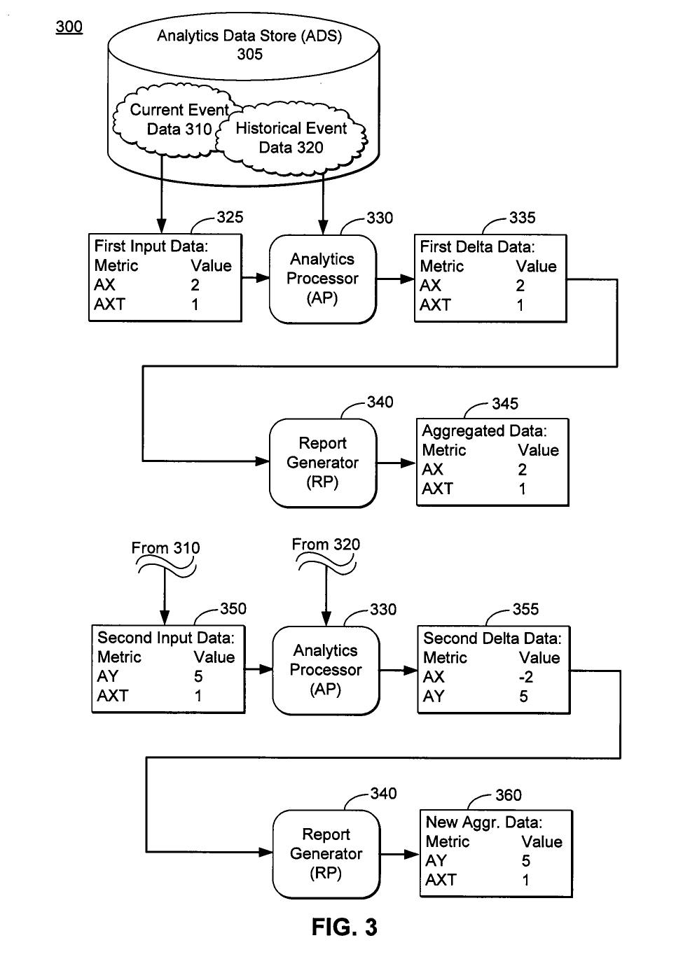

FIG. 3 illustrates an example diagram 300 of additional aspects and components related to the technique for generating and storing aggregated web traffic analytics data illustrated in

FIG. 1. In the system of 300, an analytics data store (ADS) 305 is configured to store web traffic analytics data, which may include, for example, clickstream data, hit data, parsed data, visitor data, or event data, among other types of related data, or any combination thereof. The data stored in the ADS 305, in whatever form, can include attribute names and values representing activities of a visitor on a web site. Generally, the data stored within the ADS will be referred to as “event data,” although such reference should not be construed in an overly narrow fashion, and could include data other than specifically related to an “event.” The event data from the ADS 305 can be processed by an analytics processor such as 330, to produce various metrics or “dimensional data.” As previously alluded to, examples of such metrics can include geographical information, query parameters, string values, web pages visited, most popular web pages visited, time spent by a visitor at a particular web page, products purchased, customer-specific needs, unique visitor counts, or other visitor-level dimensions, among other possibilities.

The ADS 305 includes current event data 310 and historical event data 320. Although shown here as an abstraction with two separate clouds of information, the current and historical event data is organized and stored in a particular fashion, and the historical event data is replicated at certain times and under certain conditions, and efficiently stored in a particular manner, all of which will be described in further detail below.

The analytics processor 330 can read the current event data 310 and the historical event data 320 from the ADS 305, and produce one or more metrics based on either the current or historical event data, or both. The metrics, such as AX and AXT can have different values depending on the processing stage. For example, the current event data 310 can include input data (e.g., 325 or 350), which can be read by the analytics processor 330. The input data can include various metrics such as AX and AXT. For example, the input data 325 includes AX and AXT metrics having initial values of 2 and 1, respectively. Similarly, the input data 350 includes AY and AXT metrics having values of 5 and 1, respectively. The analytics processor 330 can generate the delta data (e.g., 335 or 355) associated with the AX and AXT metrics using the current and historical event data. The AX and AXT metrics in the delta data (e.g., 335 or 355) can be assigned different values from the input data, or remain with the same values as the input data, depending on an analysis of the current and historical event data.

Alternatively, the current event data 310 may not include the AX and AXT metrics per se, but rather, the current event data 310 may include the underlying event data with which the analytics processor 330 can eventually produce the AX and AXT metrics. In either case, the analytics processor 330 produces AX and AXT metric values stored in the delta data (e.g., 335 or 355) based on at least some of the event data.

During a first iteration, after the delta data 335 is generated by the analytics processor 330, a report generator such as 340 can receive the delta data 335 and combine the delta data with aggregated data, such as 345. It is possible that the aggregated data does not yet exist during the first iteration (e.g., because of an initial iteration condition), or was not previously aggregated, and so the report generator 340 can store the delta data 335 as the new aggregated data 345 rather than combining the data. During second or subsequent iterations, the report generator 340 can combine the delta data 355 with the previously aggregated data 345 to produce the new aggregated data 360.

Reading the event data, producing the one or more metrics, generating the delta data, and combining the delta data, can be repeatedly performed over a period of time so that the new aggregated data includes the latest data available, which can then be used to generate one or more reports. In other words, the new aggregated data can include an accumulation of reportable data over a predefined period of time. In a preferred embodiment, only changes in the event data are stored to the new aggregated data in lieu of every occurrence of an event. In other words, although the ADS 305 may be collecting numerous counts, hit data, event data, etc., it is desirable to reduce the amount of information that is eventually aggregated. This can be accomplished by producing the delta data such as 355, which accounts for only the changes in the underlying data.

Details of the various metrics, including the negative AX metric in delta data 355 will not be discussed here because a detailed discussion is set forth above with reference to FIG. 1.

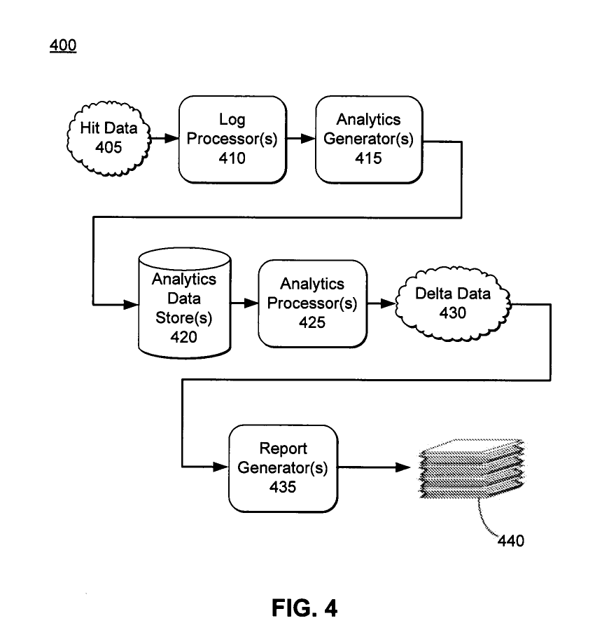

FIG. 4 illustrates a system 400 for generating delta data 430 from hit data 405, and ultimately final reports 440, according to some embodiments of the present invention. The analytics system 400 can include one or more log processor instances such as log processor(s) 410, which can receive and process hit data 405, and one or more analytics generator instances such as analytics generator(s) 415, which can receive parsed hit data from the log processor(s) 410.

The log processor(s) 410 can examine the hit data 405 and parse a visitor identification (ID) or other suitable attributes and values from the hit data 405. Further, the log processor(s) 410 can examine, parse, or otherwise process information from hit data 405, and then output the parsed data. The parsed data can be transmitted to the analytics generator(s) 415.

The hit data 405 may be available periodically or continuously, and can include, for example, data commonly referred to as “clickstream” data corresponding to visitor clicks while visiting a web site. Moreover, the hit data 110 can include one or more hits. Each hit can include attributes and values representing activities of a visitor on a web site. For example, each hit can include a time value, a visitor identification (ID), a visit identification (ID), a web page identification (ID), among other possibilities. The time value can include the data and/or time. The visitor ID is an identifier of the visitor to a web site. The visit ID is an identifier of a visit by a visitor to a web site. The web page ID is an identifier of a web page of a web site. Persons with skill in the art will recognize that hit data 110 can include other types of data besides those mentioned herein.

The analytics generator(s) 415 can process the parsed hit data 405 and store the results in one or more analytics data store instances, such as analytics data store(s) 420, and/or merge the processed hit data 405 with historical data existing in the analytics data store(s) 420, as will be further discussed in detail below. All of the analytics generator(s) 415 can be configured to operate on a single computer web server or computer system; alternatively, each of the analytics generator(s) 415 can be associated with one computer server or computer system, or groups of analytics generators can be associated with different computer servers or computer systems. If a computer server has multiple processor cores, one or more analytics generators can be associated with a corresponding one of the processor cores. The term “computer server,” “computer web server,” and “web server” are used interchangeably herein.

Data from the analytics data store(s) 420 can be processed by one or more analytics processor instances, such as analytics processor(s) 425, to produce intermediate delta data. All of the analytics processor(s) 425 can be configured to operate on a single computer server or computer system, which can be the same computer server or computer system associated with analytics generator(s) 415 and/or the analytics data store(s) 420, although this need not be the case; alternatively, each of the analytics processor(s) 425 can be associated with one computer server or computer system, or groups of analytics processors can be associated with different computer servers or computer systems. If a computer server has multiple processor cores, one or more analytics processors can be associated with a corresponding one of the processor cores.

The log processor(s) 410, analytics generator(s) 415, and analytics processor(s) 425 can comprise computer hardware, an integrated circuit such as an Application-Specific Integrated Circuit (ASIC), software, firmware, or any combination thereof. The analytics data store(s) 420 can include, for example, magnetic disk storage, non-volatile memory, volatile memory, or other suitable storage device(s) or systems such as a Local Area Network (LAN), a Storage Area Network (SAN), a Wide Area Network (WAN), etc., any of which may be coupled to the computer server or computer system associated with the analytics generator(s) 415, and any of which may persistently or temporarily store the processed hit data 405 in the form of a file, compressed file, as text, as binary, or in a database, among other possibilities. In some embodiments, the analytics data store(s) 420 may be omitted and the data instead processed in real-time.

The intermediate delta data generated by the analytics processor(s) 425 can be merged, processed, and/or partitioned into report segments by the report generator(s) 435. The report generator(s) 435 can merge and store the report data with existing report data, i.e., report segments, which are ultimately used to produce final reports 440. Although the reports 440 are illustrated as a stack of physical reports, it should be understood that the reports can be electronic in nature. As with the components mentioned above, all of the report generator(s) 435 can be configured to operate on a single computer server or computer system; alternatively, each of the report generator(s) 435 can be associated with one computer server or computer system, or groups of report generators can be associated with different computer servers or computer systems. If a computer server has multiple processor cores, one or more report generators can be associated with a corresponding one of the processor cores. The report generator(s) 435 can comprise computer hardware, an integrated circuit such as an Application-Specific Integrated Circuit (ASIC), software, firmware, or any combination thereof.

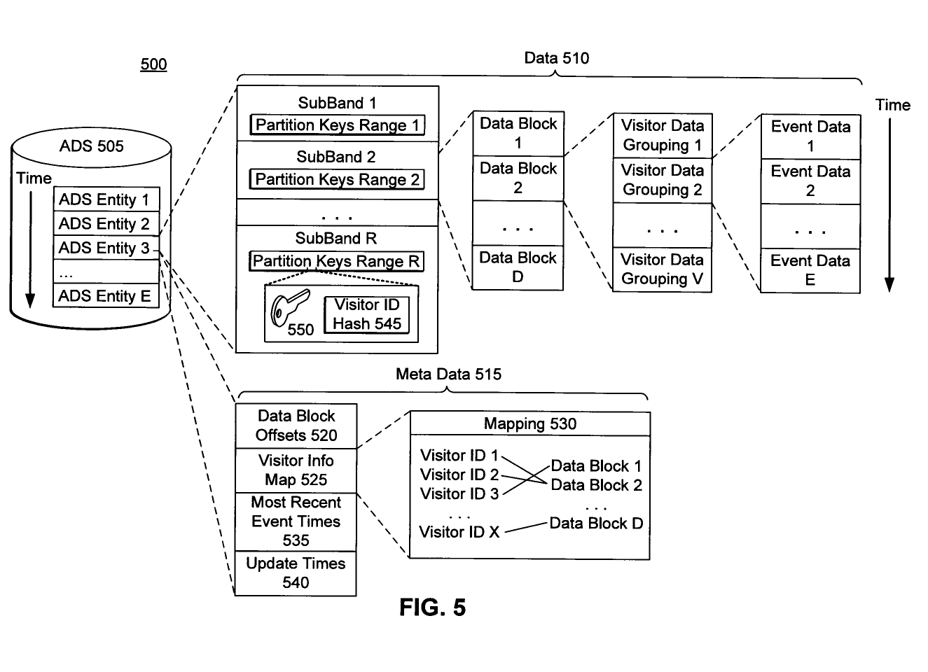

FIG. 5 illustrates an example diagram 500 of an analytics data store, and related aspects and components associated therewith. Scalability of the analytics system can be enhanced by partitioning data in various specific ways. The analytics data store (ADS) 505 includes ADS entities 1 through E. An ADS “entity” is preferably a file, but can also include a compressed file, text, binary, or a database, among other possibilities. The ADS entities can be arranged chronologically in time, in effect, dividing the data by time. Each ADS entity corresponds to a discrete time bucket, which is preferably set to between about 1 and 24 hours. The term “time bucket” is used herein to generally refer to an ADS file, which includes web traffic analytics data covering at least a predefined period of time, but can also include historical web traffic analytics data. Each time bucket is further divided into predefined organizational structures such as sub bands and data blocks, which can include event data for multiple visitors, each of whom demonstrated web traffic activity within the predefined period of time. In other words, if a particular visitor experiences current event activity within the discrete time bucket, or within the predefined period of time, then the ADS file can include the current event data associated with that visitor. In addition to storing the event data associated with the predefined period of time, the ADS file also stores historical event data for each of the visitors for all time back to a configured history limit, as will be discussed in more detail below.

One or more analytics generators, such as 415, can generate the ADS entities 1 through E and store the visitor and event data according to sub bands 1 through R. Moreover, one or more analytics processors, such as 425, can read the visitor and event data from the sub bands of the ADS entities. The analytics processors 425 can simultaneously read different data blocks within a sub band. Similarly, the analytics processors 425 can simultaneously read from different sub bands within an ADS entity. In this manner, access to the visitor and event data stored within the ADS entity is easily and efficiently provided to multiple analytics processors, which can be operating in parallel.

Each ADS entity includes data such as 510 and meta data such as 515. Information about visitors and events is organized, at the highest level within the ADS entity, using ranges of partition keys (e.g., partition key ranges 1 through R) to separate the information into sub bands of data. Each visitor has associated therewith a partition key (e.g., partition key 550), which in the preferred embodiment, can be a hash function on the visitor ID, such as visitor ID hash 545. A partition key range includes a range of multiple partition keys. The partition key ranges 1 through R correspond to the sub bands 1 through R of data, as shown in FIG. 5, and are used to logically separate and categorize the visitor and event data. Each sub band of data has associated therewith multiple data blocks, such as data blocks 1 through D. The size of each data block is configurable. A data block includes a plurality of visitor data groupings 1 through V. Each visitor data grouping is associated with one visitor to a web page or a web site, and includes event data 1 through E associated with the one visitor, which is arranged chronologically in time.

The meta data portion 515 includes, among other information, data block offset pointers 520. Each data block offset pointer is associated with a corresponding one of the configurable data blocks, such as data blocks 1 through D. More specifically, each data block offset pointer is configured to identify a location of a corresponding one of the data blocks. The data block offset pointers are accessible to determine which of the configurable data blocks are to be read for a given subset of the visitor data groupings. In other words, if it is desirable to obtain visitor data, event data, or other related data, for a specified subset of visitors, the data block offset pointers can be used to enable fast access to the desired data.

The meta data portion 515 can also include a visitor information map, such as 525. The visitor information map 525 includes a mapping 530 of visitor IDs 1 through X to a corresponding one of the data blocks 1 through D. The visitor IDs 1 through X can include visitor IDs for all visitors having associated event data stored in the ADS entity.

Further, the meta data portion 515 can also include most recent event times 535, which can be associated with the visitor IDs. In some embodiments of the invention, one or more analytics processors, such as 425, can obtain a list of visitors with activity beyond a particular time point based on the most recent event times 535 associated with the visitor IDs. The most recent event times 535 can be used to generate other related timing reports and information, particularly as it relates to visitor activity.

The meta data portion 515 can also include update times 540 for detecting changes within event data. For example, an update time can indicate a change within event data for a given visitor between processing iterations or cycles. Such timing information can be provided for some or all of the visitor IDs.

The event data, such as event data 1 through E, can include a particular format, as follows:
Event Data Example Format:
VisitorId<tab>1 2 3 4 5
Where
   1=Partition Key
   2=Event Time
   3=Data Group
   4=Data Group Version
   5=Value
Where
   Partition Key=hash value on visitor id
   Event Time=time of event
   Data Group=numeric identifying specific group of event data
      0=base
      1=hit metrics
      2=visitor data
      3=page data
      4=aggregated data
      5=custom data
      6=derived data
   Data Group Version=version of event data format, which allows for changing format in the future
   Value=comma delimited values for data group

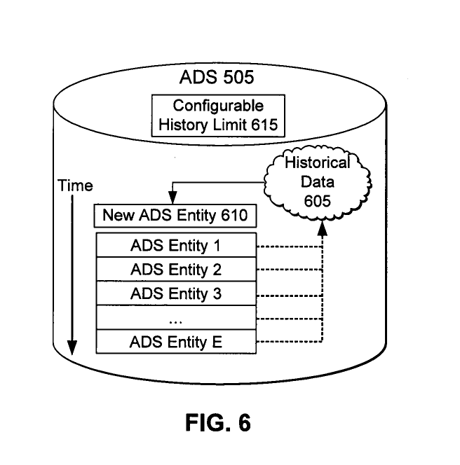

FIG. 6 shows another example of an analytics data store 505, including historical data replication and other inventive aspects. The design of the ADS entities allows for fast retrieval of historical data, thereby increasing the throughput for the analytics generators 415 and analytics processors 425 (of FIG. 4). One or more analytics generators, such as 415, can create a series of ADS entities over time, such as ADS entities 1 through E. As one “time bucket” is completed, a new ADS entity such as 610 is created to store visitor and event data for a new time bucket. Referred to herein as “history replication,” the one or more analytics generators 415 can read historical data 605 from at least one of the previously ADS entities 1 through E, and replicate the historical data 605 to at least one new ADS entity 610. It should be understood that while the entire historical data 605 can be reviewed for inclusion in the new ADS entity 610, only the changes or “deltas” between the historical data 605 and the current event data for each visitor can be stored in the new ADS entity. This is referred to herein as “delta storage.” In other words, all of the historical data 605 need not literally be copied into the new ADS entity. However, by storing the changes or “deltas,” a complete understanding of the historical data can be preserved in the new ADS entity. In an alternative embodiment, where needed, certain event data attributes can be configured to be stored for each and every occurrence, rather than only the changes in such attributes.

The new ADS entity 610 can therefore include a complete history of event data for each of a plurality of visitors back to a configurable history limit 615. The one or more analytics processors 425 can then produce one or more metrics, such as visitor-level metrics, using at least some of the complete history of event data for each of the visitors. Preferably, the new ADS entity 610 is readable and writeable, and the previously generated ADS entities 1 through E are only readable, thereby preventing accidental over-writing or deletion of historical event data. This also facilitates incremental and efficient backup and restore of the current and historical analytics data because previously generated ADS entities are not being changed, but only read from. This can be accomplished by simply copying some or all of the new or historical ADS entities from the ADS 505 to a backup storage medium.

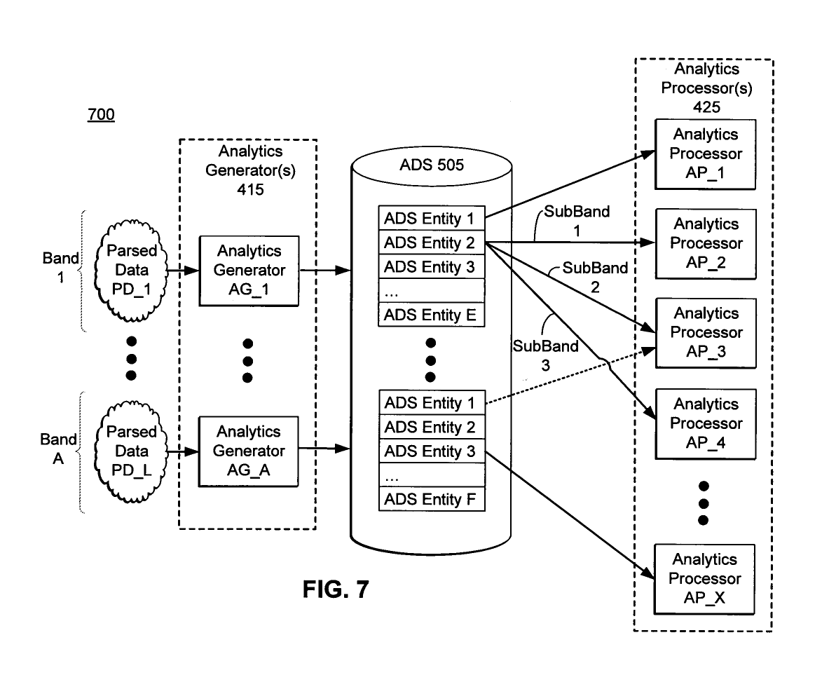

FIG. 7 shows a system 700 for processing information organized into bands 1 through A and sub-bands 1 through 3, thereby efficiently processing and storing the information according to another example embodiment of the invention. As illustrated in FIG. 7, analytics generators 415 such as analytics generators AG_1 through AG_A, can receive and process parsed data PD_1 through PD_L over different pipelines, and store the results in ADS 505 associated with, for example, Band_1 through Band_A. Each analytics generator 415 may be associated with a corresponding one band. For example, AG_1 is associated with Band_1, AG_A is associated with Band_A, and so forth.

As used herein, the term “band” is essentially a storage partition and/or associated processing pipeline of a predefined group of data based on predefined criteria. In other words, a range of data can be assigned to a given band, and any mechanism can be used to separate the data among the bands; preferably, a partition key is used to determine which band receives which data. The partition key is preferably a hash function or modulo of a visitor ID. For example, hit data 405 (of FIG. 4) can be partitioned into one or more bands, such as Band_1 through Band_A. Typically, although not required, one band will be associated with one computer server. Alternatively, more than one band can be associated with one computer server, although there is some overhead in managing more than one band on a single computer server. Preferably, each of Band_1 through Band_A contains a predefined group of data based on their own predefined criteria.

The partitioning of the hit data 405 can be based, for example, on a partition key, preferably a hash function or modulo of a visitor ID. The visitor ID can be parsed from the hit data. The hit data can include event attributes, and/or different visitor IDs, among other types of data. For example, if there are A number of bands, the assigned band for a particular visitor can be determined by performing the function of visitor ID modulo A. Further, the partitioning of the hit data can be based, for example, on a geographic determination so that all visitors from one location (e.g., country, state, city, etc.) are associated with one band, and all visitors from another different location are associated with another band, i.e., selected from Band_1 through Band_A. It should be understood that other suitable deterministic functions can be used to associate hit data and/or visitors with different bands.

Each of the bands can have associated therewith certain analytics generators and sets of ADS entities. For example, Band_1 can have associated therewith analytics generator AG_1 and ADS entities 1 through E. Similarly, Band_A can have associated therewith analytics generator AG_A and ADS entities 1 through F. As previously discussed above, the analytics generators can create ADS entities, thereby gradually filling time buckets and replicating historical event data into new ADS entities.

Analytics processors 425 can read and process data from one or more of the ADS entities, irrespective of which band the ADS entity belongs. In addition, multiple analytics processors can read and process data from different sub bands within a single ADS entity. For example, FIG. 7 illustrates analytics processors AP_2, AP_3, and AP_4 reading and processing data from sub bands 1, 2, and 3, respectively, all of which are associated with ADS entity 2. Although three sub bands are illustrated, it should be understood that any number of sub bands can be used. In addition, while some aspects of bands and sub bands are similar in nature, such as the shared concept of dividing data using partition keys or ranges of partition keys, the number of sub bands is independent of the number of bands. The analytics processors can be dynamically or automatically assigned to process information from the ADS entities and/or sub bands. The number of analytics processors X need not be equal to the number of bands A, nor the number of ADS entities, nor the number of sub bands. Rather, the number of analytics processors X is configurable based on loading and performance needs. The associations of analytics processors to ADS entities or sub bands can be dynamically and automatically adjusted based on the processing load of the analytics system.

Each of the analytics processors, such as AP_1 through AP_X, can read and merge data from one or more ADS entities, such as ADS entities 1 through E associated with Band_1, or from ADS entities 1 through F associated with Band_A. In an alternative embodiment, an analytics processor, such as AP_3, is associated with and/or can read from more than one band, such as Band_1 and Band_A, as indicated by the dashed arrow. Moreover, any analytics processor can read from any ADS entity associated with any band, and from any sub band or data block within an ADS entity. In this manner, the analytics processors 425 can simultaneously and efficiently process data from the ADS 505 to quickly produce intermediate delta data, such as delta data 430, thereby providing horizontal scaling of analytics data storage and processing.

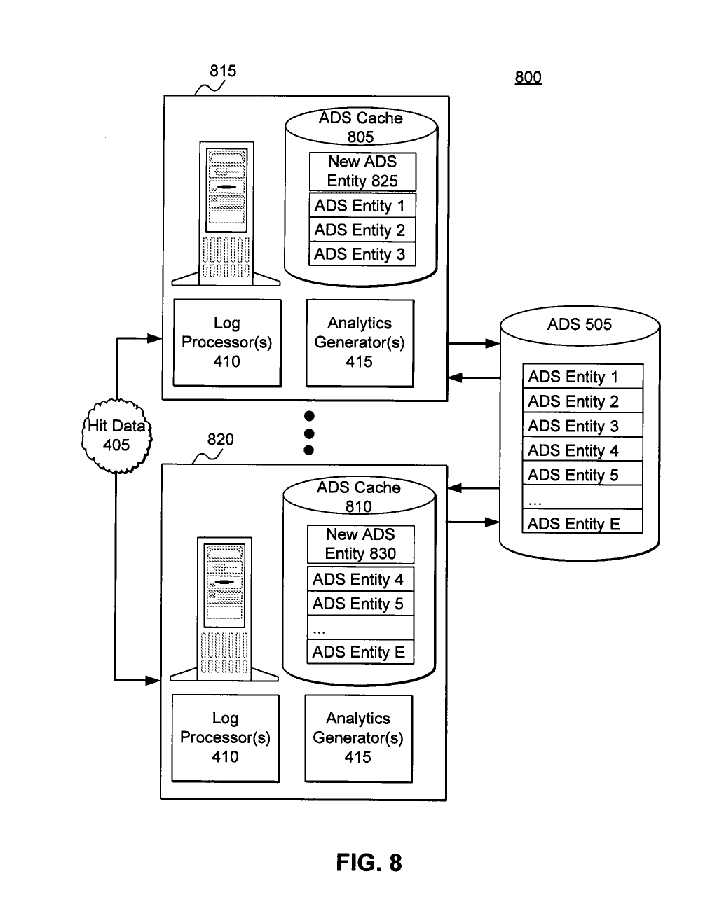

FIG. 8 shows a system 800 for caching portions of the analytics data store using local machines 815 and 820, according to yet another example embodiment of the invention. To improve scalability and enhance performance, a first local machine 815 can cache a first portion of the ADS entities such as ADS entities 1 through 3, and a second local machine 820 can cache a second portion of the ADS entities such as ADS entities 4 through E. The first local machine 815 can include one or more analytics generators 415 to generate a new ADS entity 825. Similarly, the second local machine 820 can include one or more analytics generators 415 to generate a new ADS entity 830.

The local machines can then independently copy the new ADS entities to the ADS 505. Such an approach allows each local machine to process a band of data independently of other bands or machines. In this embodiment, the ADS 505 functions as a common file store. The analytics generators 415 that are operating on the local machines can read information (i.e., from one or more pre-existing ADS entities), process the information, and generate new ADS entities independent of one another, and simultaneously with each other. Once copied to the ADS 505, the analytics processors 425 (of FIG. 4) can read the new ADS entities from the common file store, process the same, and generate the intermediate delta data independently of the processing and generation of the ADS entities that is occurring on the local machines 815 and 820. It should be understood that while two local machines are illustrated, any number of local machines can be configured to perform similar operations.

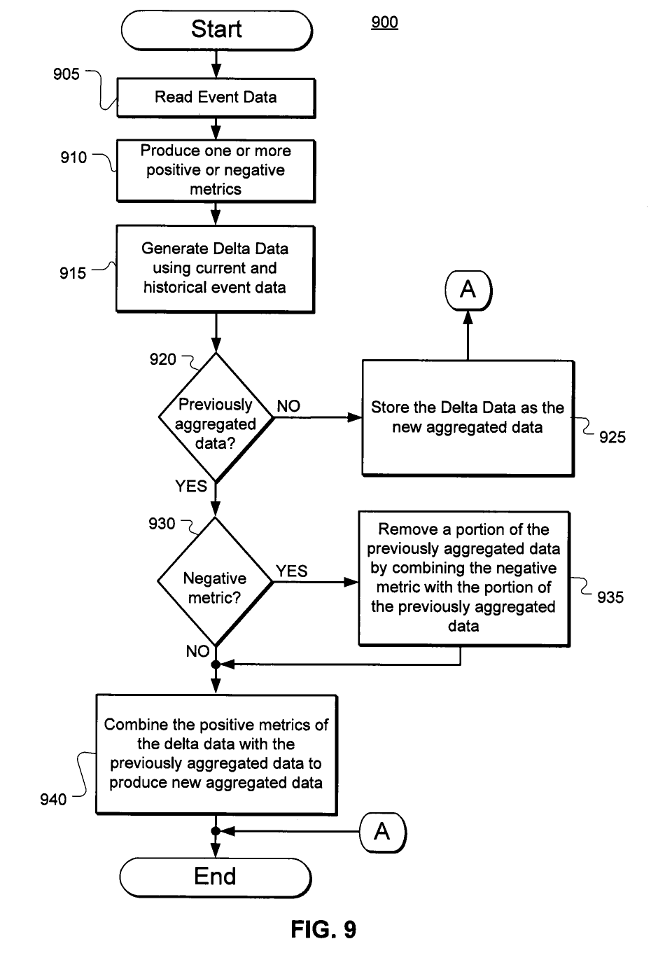

FIG. 9 shows a flow diagram 900 for reading, processing, and storing event data to produce aggregated data according to an example embodiment of the invention. At 905, event data is read from an application data store (ADS). The event data can include current event data or historical event data, or a combination thereof. The current and historical event data is associated with one or more visitors to a web page or a web site. At 910, one or more metrics can be produced based on the current or historical event data, or a combination thereof. At 915, delta data can be generated using the current and historical event data. The delta data is also associated with, and may include, the one or more metrics. A determination is made at 920 whether data was previously aggregated, or otherwise already exists. If no, the flow proceeds to 925 where the delta data is stored as the new aggregated data and then through path A to end. Otherwise, if yes, the flow proceeds to 930, where another determination is made whether the one or more metrics includes a negative metric. If yes, the flow proceeds to 935 and a portion of the previously aggregated data is removed by combining the negative metric with the portion of the previously aggregated data. The general flow then proceeds to 940 where the positive metrics of the delta data are combined with the previously aggregated data to produce new aggregated data.

It should be understood that various arrangements and combinations of the disclosed elements of the distributed analytics system can be structured to produce similar results, and the inventive aspects are not limited to the particular and specific illustrated arrangements. It should be understood that other configurations are contemplated, and the inventive aspects are therefore not to be limited to any one configuration.

The following discussion is intended to provide a brief, general description of a suitable machine or machines in which certain aspects of the invention can be implemented. Typically, the machine or machines include a system bus to which is attached processors, memory, e.g., random access memory (RAM), read-only memory (ROM), or other state preserving medium, storage devices, a video interface, and input/output interface ports. The machine or machines can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines can include embedded controllers, such as programmable or non-programmable logic devices or arrays, Application Specific Integrated Circuits (ASICs), embedded computers, smart cards, and the like. The machine or machines can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciated that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the invention can be described by reference to or in conjunction with associated data including functions, procedures, data structures, application programs, etc. which when accessed by a machine results in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having illustrated and described the principles of our invention in a preferred embodiment thereof, it should be readily apparent to those skilled in the art that the invention can be modified in arrangement and detail without departing from such principles. We claim all modifications coming within the spirit and scope of the accompanying claims.

We claim:

1. A method for storing web traffic analytics data, comprising:
reading current event data and historical event data associated with a visitor from an analytics data store;
producing one or more metrics based on at least the current event data;
generating first delta data associated with the one or more metrics using the current and historical event data; and
storing the first delta data as aggregated data.

2. The method of claim 1, further comprising:
generating second delta data associated with the one or more metrics using the current and historical event data; and
combining the second delta data with the previously aggregated data to produce new aggregated data.

3. The method of claim 2, wherein generating the second delta data associated with the one or more metrics further comprises generating a negative metric.

4. The method of claim 3, further comprising removing a portion of the previously aggregated data by combining the negative metric with the portion of the previously aggregated data.

5. The method of claim 2, wherein reading the event data and generating the first and second delta data are performed by an analytics processor.

6. The method of claim 2, wherein combining the second delta data further comprises a report generator combining the second delta data with the previously aggregated data to produce the new aggregated data.

7. The method of claim 2, wherein reading the event data, producing the one or more metrics, generating the delta data, and combining the delta data, are repeatedly performed over a period of time.

8. The method of claim 7, wherein the new aggregated data includes an accumulation of reportable data over the period of time.

9. The method of claim 8, further comprising storing changes in the event data to the new aggregated data in lieu of every occurrence of an event.

10. The method of claim 2, wherein generating the first and second delta data further comprises reviewing the historical event data and comparing the current event data to the historical event data.

11. The method of claim 2, wherein the new aggregated data includes one or more unique visitor counts.

12. The method of claim 1, wherein producing the one or more metrics further comprises producing the one or more metrics based on the current event data and the historical event data.

13. The method of claim 1, wherein storing further comprises storing the first delta data as the aggregated data when the aggregated data does not previously exist, the method further comprising combining the first delta data with the aggregated data to produce new aggregated data when the aggregated data previously exists.

14. The method of claim 1, wherein the one or more metrics include a visitor-level dimension.

15. The method of claim 1, wherein the one or more metrics include a web page dimension.

16. The method of claim 1, wherein the one or more metrics include at least one of a geographic dimension, a time dimension, and a product dimension.

17. A system for efficient storage and retrieval of analytics data, comprising:
an analytics data store including a plurality of analytics data store entities arranged chronologically in time, each analytics data store entity including:
a plurality of sub bands of data, each sub band of data being associated with a plurality of configurable data blocks; and
a meta data portion having offset pointers, each offset pointer being associated with a corresponding one of the plurality of configurable data blocks.

18. The system of claim 17, wherein:
each of the data blocks includes a plurality of visitor data groupings;
each visitor data grouping is associated with one of a plurality of visitors; and
each visitor data grouping includes event data arranged chronologically in time.

19. The system of claim 18, wherein the meta data portion having offset pointers is accessible to determine which of the configurable data blocks are to be read for a given subset of the plurality of visitor data groupings.

20. The system of claim 17, wherein each offset pointer is configured to identify a location of a corresponding one of the plurality of data blocks.

21. The system of claim 17, wherein the meta data portion comprises a first meta data portion, the system further comprising a second meta data portion including a visitor information map.

22. The system of claim 21, wherein the visitor information map includes a mapping of each of a plurality of visitor identifications to a corresponding one of the data blocks.

23. The system of claim 22, wherein the second meta data portion further comprises most recent event times associated with the plurality of visitor identifications.

24. The system of claim 23, further comprising one or more analytics processors that are configured to obtain a list of visitors with activity beyond a time point based on the most recent event times associated with the plurality of visitor identifications.

25. The system of claim 22, wherein the second meta data portion further comprises an update time for detecting changes within event data between processing cycles for each of the plurality of visitor identifications.

26. The system of claim 17, wherein the size of each data block is configurable.

27. The system of claim 17, wherein each of the plurality of sub bands is associated with a range of partition keys.

28. The system of claim 27, wherein each of the partition keys includes a hash of a visitor identification.

29. The system of claim 17, wherein each of the analytics data store entities corresponds to an analytics data store file.

30. The system of claim 29, wherein each analytics data store file includes data associated with a discrete time bucket.

31. The system of claim 30, wherein each analytics data store file includes event data for each of a plurality of visitors experiencing event activity within the discrete time bucket.

32. The system of claim 31, wherein for a given visitor, the event data includes historical event data for said given visitor for all time back to a configurable history limit, and includes current event data for said given visitor within the discrete time bucket.

33. The system of claim 17, further comprising:
one or more analytics generators to generate the plurality of analytics data store entities and to store the data according to the plurality of sub bands; and
one or more analytics processors to read the data from the plurality of sub bands of the analytics data store entities.

34. The system of claim 33, wherein the one or more analytics generators are configured to read historical data from at least one of the analytics data store entities, and to replicate the historical data to at least one new analytics data store entity.

35. The system of claim 34, wherein the new analytics data store entity includes a complete history of event data for each of a plurality of visitors back to a configurable history limit.

36. The system of claim 35, wherein the one or more analytics processors are configured to produce one or more visitor-level metrics using at least some of the complete history of event data for each of the plurality of visitors.

37. The system of claim 34, wherein the at least one new analytics data store entity is readable and writeable, and previously generated analytics data store entities are readable.

38. The system of claim 17, further comprising:
a first local machine to cache a first portion of the plurality of analytics data store entities; and
a second local machine to cache a second portion of the plurality of analytics data store entities.

39. The system of claim 38, wherein:
the first local machine includes a first analytics generator to generate a first new analytics data store entity;
the second local machine includes a second analytics generator to generate a second new analytics data store entity; and
the first and second local machines are configured to copy the first and second new analytics data store entities, respectively, to the analytics data store.

40. An article comprising a storage-readable medium having associated data that, when executed by a machine, results in a machine:
reading current event data and historical event data associated with a visitor from an analytics data store;
producing one or more metrics based on at least the current event data;
generating first delta data associated with the one or more metrics using the current and historical event data; and
storing the first delta data as aggregated data.

41. The article of claim 40, further comprising:
generating second delta data associated with the one or more metrics using the current and historical event data; and
combining the second delta data with the previously aggregated data to produce new aggregated data.

42. The article of claim 41, wherein generating the second delta data associated with the one or more metrics further comprises generating a negative metric.

43. The article of claim 42, further comprising removing a portion of the previously aggregated data by combining the negative metric with the portion of the previously aggregated data.

44. The method of claim 41, wherein generating the first and second delta data further comprises reviewing the historical event data and comparing the current event data to the historical event data.
